(19) United States
(12) Patent Application Publication
(10) Pub. No.: US 2023/0364858 A1
(43) Pub. Date: Nov. 16, 2023

(54) COMPOSITE MATERIAL WITH A GRADED OR HOMOGENEOUS MATRIX, PRODUCTION METHOD THEREOF, AND USES OF SAME

(71) Applicants: UNIVERSITE DE LORRAINE, Nancy (FR); CENTRE NATIONAL DE LA RECHERCHE SCIENTIFIQUE, Paris (FR); ECOLE NATIONALE SUPERIEURE D'ARTS ET METIERS, Paris (FR)

(72) Inventors: Paul LOHMULLER, Metz (FR); Samuel KENZARI, Andilly (FR); Julien FAVRE, Saint-Etienne (FR); Pascal LAHEURTE, Forbach (FR)

(21) Appl. No.: 18/270,998

(22) PCT Filed: Jan. 6, 2022
(86) PCT No.: PCT/EP2022/050198

§ 371 Date: Jul. 5, 2023

(30) Foreign Application Priority Data
Jan. 7, 2021 (FR) FR2100132

(51) Int. Cl. B29C 64/153; B22F 10/28; B29C 71/00; B22F 10/62

(52) U.S. Cl. CPC B29C 64/153; B22F 10/28; B29C 71/0009; B22F 10/62; B29K 2105/041

(57) ABSTRACT

The present invention relates to a composite material with a graded or homogeneous matrix, the production method thereof, and the uses of same.

The present invention relates to a composite material with a graded or homogeneous matrix, production method thereof, and uses of same.

The composite materials constituted of a matrix of a first material containing a second material, for example metal/metal composites, are particularly advantageous in numerous fields, for example as light robotic components or within orthopaedic implants.

Indeed, each of these materials has specific features, and when they are combined within a composite, said materials are able to form a material with modified, often superior properties.

These composite materials can generally be obtained by powder sintering methods to form a matrix of the first material, which is thus infiltrated by the second.

However, these methods do not make it possible to obtain homogeneous or graded composite materials, in particular concerning the physical properties.

Furthermore, they can require additional debinding, or surface treatment steps (nitridation, for example).

The invention aims to propose a method for producing composite material, constituted of a matrix of a first material containing a second material, which avoids the abovementioned disadvantages.

Thus, the method according to the invention makes it possible to easily and controllingly obtain homogeneous composite materials, as regards the structure of the matrix, and therefore homogeneous in terms of physical properties, or, if desired, graded materials of pore size and therefore of physical properties. It is thus possible to locally control the spatial distribution of the second material within the porous lattice of the matrix of the first material to target specific volume and/or surface properties.

Another aim of the invention is to provide a versatile, flexible method, enabling an easy first material/second material coupling with a very large variety of first and second materials.

Thus, according to a first aspect, the invention relates to a device comprising a matrix of a first material defining an assembly (P) of interconnected pores, which comprise for all or some of them, a second material, and have a size t of around 70 to around 700 μm, the size of at least 95% of said pores of the assembly (P) being equal to t±10%, or forming a gradient between a size (tₐ)±10% and a size (t_{b})±10%, and (tₐ) and (t_{b}) of around 70 to around 700 μm, and (tₐ)<(t_{b}).

By “pores having a size t of between around 70 to around 700 μm, the size of at least 95% of said pores being equal to t±10%, it is understood therefore that at least 95% of said pores have a size of t−10% t+10%, t being a discrete and unique size value being located in the interval going from around 70 to around 700 μm. Similarly, (tₐ) and (t_{b}) are discrete and unique size values, both being located in the interval going from around 70 to around 700 μm.

By “gradient”, this means, in particular, that the size of the interconnected pores varies in the space of the assembly (P) while having a value of (tₐ) to (t_{b}).

By “interconnected pores”, this means, in particular, pores linked to one another, so as to enable, for all or some of them, the circulation, in particular, by capillarity, of the second material or of a precursor of the second material, such as defined below within the assembly (P) or of said part of the assembly (P).

According to a particular embodiment, the first material is constituted or comprises a metal or a metal alloy; a polymer; or a ceramic; the first material being, in particular, constituted of a metal or a metal alloy.

According to a particular embodiment, the first material is constituted or comprises a metal chosen from among Ti, Al, Fe, Co, Cr and their alloys, in particular, Ti—Al, Al—Si, Fe—C, Cu—Sn, Cu—Zn, or Co—Cr.

According to a particular embodiment, the first material is constituted or comprises a thermoplastic polymer, in particular chosen from among polyamides, for example Nylon 6, Nylon 11 and Nylon 12, amide copolymers, for example nylon 6-12, polyacetates, polyethylenes, polyetheretherketones (PEEK), acrylonitrile butadiene styrenes (ABS), polylactic acids (PLA), polyethylene terephthalates (PET), high-density polyethylenes (HDPE), polyetherimides (ULTEM), and their mixtures.

According to a particular embodiment, which the first material is constituted or comprises a photopolymerisable resin, in particular vat-photopolymerisable, in particular chosen from among acrylate compounds, urethane-acrylate compounds, epoxy compounds, epoxy-acrylate compounds, vinylether compounds and their mixtures.

By “vat-photopolymerisable”, this means polymerizable by vat polymerisation, a technique well-known to a person skilled in the art, also known as vat photopolymerisation.

According to a particular embodiment, the first material comprises, further to the resin, a polymerisation initiator and/or a colourant.

According to a particular embodiment, the first material is constituted or comprises a ceramic chosen from among oxides, for example alumina (Al₂O₃), nitrides, for example AIN, carbides, for example WC and TiC, borides, for example TiB, and ceramic/metal composites, for example Al₂O₃/Al composites, in particular the cermet Al₂O₃+5% Al.

By “cermet”, this means, in particular, a composite material composed of a ceramic reinforcement and a metal matrix.

According to a particular embodiment, the second material is such that its melting point or its liquid state temperature is less than the melting point or liquid state temperature of the first material, in particular less than the melting point of the first material, in particular preferably of at least 20%.

The liquid state temperature is in particular considered for a resin or a fluid.

According to a particular embodiment, the second material is chosen from among:
organic compounds, in particular:
organic solvents, more specifically methanol, acetone and ethanol;
hydrocarbons;
biological liquids, for example, blood;
polymers, more specifically casting resins, for example polyepoxides, acrylic resins, vinyl resins, polyurethanes and polyesters;
inorganic compounds, in particular:
water;
metals and their alloys, in particular containing the elements Al, Sn, Zn, Cu, Fe, Ag, Au, Hg and/or Ga;
composites, in particular composite resins containing magnetic fillers, for example NdFeB, ferromagnetic ceramics: ferrite, or magnetisable ferromagnetic ceramics, for example iron-based composites.

According to a particular embodiment, the first material is titanium or a titanium alloy, or polyamide and the second material is a polyepoxide, aluminium or an aluminium alloy, or a liquid, for example, water.

By “liquid”, this means, in particular, an element or compound being in the liquid state at ambient temperature, for example at 25° C., and under 1 atm.

The liquid is, for example, water, an organic solvent, a hydrocarbon or a biological liquid, in particular, blood.

According to a particular embodiment, the size t is between around 70 and around 700 μm; or the size (tₐ) is between 70 and around 350 μm, and the size (t_{b}) is between around 350 and around 700 μm.

According to a particular embodiment, the matrix is a lattice structure matrix.

According to a particular embodiment, the lattice structure matrix is constituted or comprises an elementary geometric pattern which is repeated periodically in the space, said pattern being able to undergo geometric deformations according to its position in the space.

This repetition can be done by translation of the pattern, and/or by any symmetry, for example central, axial or planar.

Thus, in particular “pattern” means a pattern of a Bravais lattice, for example, a cubic, parallelepiped, rhombohedral pattern, of the hexagonal prism type, etc.

According to a particular embodiment, the pattern is a cubic pattern.

According to a particular embodiment, the lattice structure matrix is a beam structure matrix, the diameter of said beams being, in particular, of 100 to 300 μm.

According to a particular embodiment, the beam structure matrix is graded with relative densities. In this case, in particular, the size of the beams varies within the matrix, with a constant arrangement.

According to a particular embodiment, the beam structure matrix is topology-graded, in particular obtained via patterns of the same dimensions, which all fall under a cube, with identical beam lengths and diameters, and where only the arrangement of the beams is modified continuously within the matrix.

According to another aspect, the invention relates to a method for producing a device such as defined above, comprising a step (i) of infiltrating all or some of the pores of the matrix of the first material, by the second material or a precursor of the second material, in liquid form to obtain said device.

It must be noted that all the particular embodiments described above relative to the device are also applied in this case, individually or in combination.

According to a particular embodiment, the infiltration of step (i) is done by capillarity.

According to a particular embodiment, the infiltration step (i) is carried out at a temperature of between 20 and 35° C., the second material or its precursor being, in particular, a liquid chosen from among organic compounds, inorganic compounds, polymers or their precursors, composites, metals chosen from among Hg and Ga.

According to a particular embodiment, the infiltration step (i) is carried out at a temperature greater than the melting point of the second material or of its precursor, in particular at a temperature corresponding to (the melting point of the second material or of its precursor+around 50° C.), the second material being, in particular, a metal or a metal alloy, for example, Al.

According to a particular embodiment, the infiltration step (i) is carried out under a controlled atmosphere and/or pressure.

According to a particular embodiment, the precursor of the second material is:
A precursor forming the second material by drying or thermal treatment; and/or
A composition comprising a monomer and optionally a polymerisation catalyst, the second material being the corresponding polymer; or
A composition comprising a polymer and a cross-linking agent or a hardener, the second material having the corresponding cross-linked or hardened polymer.

According to a particular embodiment, the matrix of the first material is obtained by selective laser printing.

According to a particular embodiment, the matrix of the first material is obtained by selective laser melting (SLM) on a powder bed, the first material being, in particular, a metal, or a metal alloy, or a cermet composite.

Selective laser melting can be carried out by any technique, well-known to a person skilled in the art. Generally, by means of a mobile laser beam, the metal powder is selectively locally sintered in layers, thus solidifying transverse sections of the matrix to be obtained.

Such a technique can, for example, be proposed by SLM Solutions, ConceptLaser, EOS, 3DSystems/Phenix, Renishaw, or Additive Industries.

According to a particular embodiment, the matrix of the first material is obtained by selective laser sintering (SLS) on a powder bed, the first material being, in particular, a polymer.

Selective laser sintering can be carried out by any technique, well-known to a person skilled in the art. Generally, by means of a mobile laser beam, polymer powder is selectively locally sintered in layers, thus solidifying transverse sections of the matrix to be obtained.

Such a technique can, for example, be proposed by EOS, 3DSystems/Phenix, Sinterit, Sharebot or Sintratec.

According to a particular embodiment, the matrix of the first material is obtained by stereolithography (SLA), the first material being, in particular, a photopolymerisable resin, more specifically, a vat-photopolymerisable resin.

The photopolymerisation can be carried out by any technique, well-known to a person skilled in the art. Generally, by means of a mobile laser beam, a photopolymer is selectively, locally, polymerised in layers and is solidified there.

Such a technique can, for example, be proposed by 3DSystems/Phenix, Formlabs or DWS.

According to a particular embodiment, the selective laser printing step is preceded by a step of digitally pre-treating the matrix.

According to a particular embodiment, which infiltration step is followed by a drying and/or thermal treatment step, in particular to obtain the second material from a precursor.

According to another aspect, the invention relates to a product which can be obtained by the method such as defined above.

It must be noted that all the particular embodiments described above relative to the device or to the device are also applied in this case, individually or in combination.

According to another aspect, the invention also relates to the use of a device such as defined above or of a product such as defined above, in the automotive, aerospace, aeronautics or biomedical field.

It must be noted that all the particular embodiments described above relative to the device, to the method or to the product are also applied in this case, individually or in combination.

According to a particular embodiment, the invention relates to the use of a device such as defined above or of a product such as defined above, as an implantable system, for example enabling a localised salting-out of medicine(s).

According to a particular embodiment, the invention relates to the use of a device such as defined above or of a product such as defined above, as a perpetual pumping system, in particular as a filtering system or in the biomedical field.

### Definitions

In the sense of the present description, the deformation percentages refer, in particular, to length percentages with respect to the initial size of the object, unless indicated otherwise.

Such as is understood in this case, the value ranges in the form of “x-y” or “from x to y” or “between x and y” include the limits x and y, as well as the integers between these limits. As an example, “1-5” or “from 1 to 5” or “between 1 and 5” mean integers 1, 2, 3, 4 and 5. The preferred embodiments include each integer taken individually in the value range, as well as any sub-combination of these integers. As an example, the preferred values for “1-5” can comprise the integers 1, 2, 3, 4, 5, 1-2, 1-3, 1-4, 1-5, 2-3, 2-4, 2-5, etc.

Such as used in this case, the term “around” refers, in particular, to a range of values at ±10% of a specific value. For example, the term “around 100” comprises the values of 100±10%, i.e. the values of 90 to 110.

### FIGURES

FIG. 1 illustrates epoxy/titanium devices according to example 1, for which the infiltration height of the epoxy in the titanium matrix is indicated.

FIG. 2 illustrates a metal/metal (Aluminium/Titanium) device according to example 2.

FIG. 3 illustrates an example of selective infiltration in an architectural lattice, in particular which can be obtained according to example 1. The line indicates the infiltration height of the infiltrator in the infiltrated matrix.

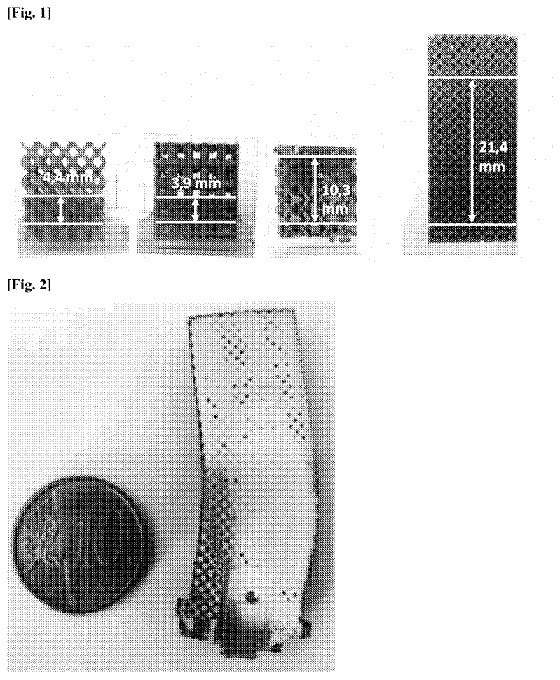

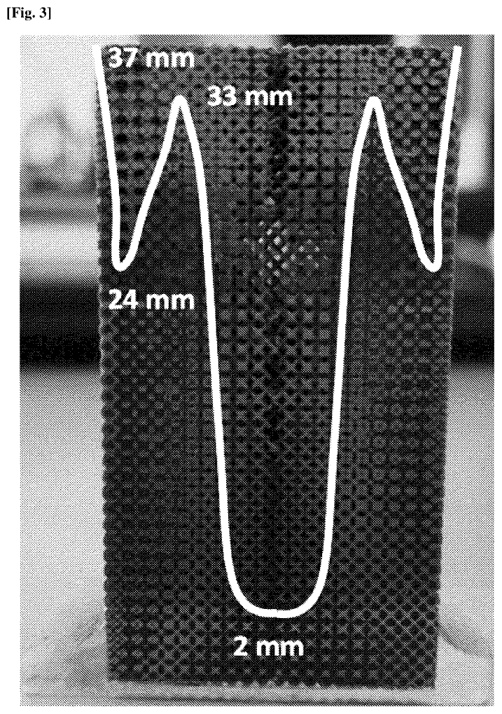

### EXAMPLES

### FIG. Example 1: Production of an Epoxy/Ti Device According to the Invention

Digital pretreatment:

The patterns used to generate the matrix are obtained similarly to the Brevais lattice of crystallography. They are composed of an periodic elementary volume (cube, hexagon, etc.), of a symmetry system compatible with the elementary volume and of the placement of a first beam in this volume. The correct positioning of the first beam coupled with the chosen symmetry system enables the generation of an infinity of different structures, called lattices. In fact, for two patterns, when the first beams have a positioning in the close elementary volume, then the two structures obtained are able to present close spatial organisations.

A semi-phenomenological capillary rise model can, if desired, make it possible to compare the performances of a pattern with respect to another, according to the size of the pattern and of the diameter of its beams. Thus, in the case of a homogeneous matrix, it can enable the determination of the pattern and of its size which can be the most suitable for a target infiltration height. The selected pattern is then duplicated and positioned so as to completely line the target volume.

The model used is a finite difference formulation of the Fries et al. model (Fries et al., Colloid and Interface Science, vol. 320, pp. 259-263, 2008). The model considers the impact of the infiltrating fluid and of the infiltrating triptych—infiltrated—atmosphere, through the density and the viscosity of the fluid, as well as the surface tension and the contact angle between the infiltrating and the infiltrated. It is also according to the characteristic dimensions of the matrix (size of the elementary volumes), of the topology (determination of the sizes of equivalent porosities and of the permeabilities according to the position in the elementary volume, coupled with a calculation of the finite difference capillary rise heights). Finally, for each topology of the database, the model makes it possible to determine the heights and infiltration time for a range of relative densities of between 5 and 60%. The phenomenological aspect is linked to the calculation of the permeability obtained via Jackson and James phenomenological equations (Jackson and James, Canadian Journal of Chemical Engineering, vol. 64, pp. 364-374, 1986).

In the case of a graded lattice, the volume to be filled is generally initially separated into sub-volumes. To each sub-volume, a target infiltration height is attributed, which makes it possible to determine patterns for each sub-volume. Finally, the selection of final patterns is made generally, such that the passage from one pattern to the other is as continuous as possible. The selected patterns are generally of the same dimensions, such that they generally all fall under a cube, with identical beam lengths and diameters, and where only the arrangement of the beams is modified continuously within the matrix. The chosen patterns make it possible to then line each sub-volume, then finally, the sub-volumes are assembled so as to generate the final matrix.

The matrix used in the present example falls, in particular, under a cubic (or cylindrical) volume of 15 mm on the side (or diameter) and of 30 mm by height. For homogeneous lattices, the dimension of the patterns is 1.5 mm and the diameter of the beams is 300 μm. For graded lattices, the dimension of the patterns is 1 mm and a beam diameter is 250 μm.

Selective laser melting:

Selective laser melting has been carried out on an SLM 280HL machine of SLM Solutions. The powder used for the manufacture is a Ti6A14V alloy (grade 5 Ti), of a spherical morphology (characteristic of an atomised powder) and having an average grain size of around 50 μm. The manufacture is carried out under a neutral atmosphere (Ar) to avoid, if desired, possible oxidation. The main parameters used are as follows: laser power of 200 W, lasering speed of 1175 mm/s, a distance between two laser lines of 80 μm and a layer thickness of 30 μm. All of the matrices are manufactured on a Ti6A14V manufacturing plate. At the end of manufacture, the matrices are manually detached from the plate, then cleaned with ultrasound for 5 minutes, so as to remove the non-melted powder. Finally, a step of steaming at 90° C. for 4 hours makes it possible to discharge residual humidity.

Infiltration step:

The epoxy+hardener mixture used has a ratio of around 7/1 for a total volume corresponding to around 1.5 times the volume to be infiltrated. This is directly poured into a retention container. The matrix obtained such as described above is introduced into the mixture through the top, such that around 1 mm of the lower part of the matrix is immersed. It all is kept in position until the complete hardening of the epoxy resin. Finally, the composite is then cut within the retention container.

### Example 2: Production of an Al/Ti Device According to the Invention

The digital pretreatment and selective laser melting steps are similar to those described in example 1.

Infiltration step:

The infiltration device is generally composed of the fixed matrix, thanks to a screw at the centre of a retention container. This container contains an inclined part so as to drive the aluminium flow towards the matrix. Two aluminium fillers (infiltrator) are placed on either side of the matrix at a distance of around 10 mm. The volume of the fillers must generally, as a minimum, correspond to 1.5 times the volume to be infiltrated. The matrix-infiltrator-vat assembly is placed in a furnace under a controlled Ar atmosphere. The thermal cycle consists, in the present example, of a vacuum heating at 350° C. for 2 hours so as to enable the degassing of the elements of the device. A second heating, at 800 mbar of Ar at 720° C. enables the melting of the aluminium fillers (for 5 to 45 minutes according to the matrix). After cooling, the part can be unscrewed from the vat and trimmed, before a possible post-treatment or finalisation.

1. Method for producing a device comprising a matrix of a first material defining an assembly of interconnected pores, which comprises for all or some of them, a second material, and have a size t of around 70 to around 700 μm, the size of at least 95% of said pores of the assembly being equal to t±10%, or forming a gradient between a size (tₐ)±10% and a size (t_{b})±10%, with (tₐ) and (t_{b}) of around 70 to around 700 μm, and (tₐ)<(t_{b}), said method comprising an infiltration step (i), in particular by capillarity, of all or some of the pores of the matrix of the first material, by the second material or a precursor of the second material, in liquid form, to obtain said device, the matrix of the first material being obtained by:
selective laser melting on a powder bed, the first material being, in particular, a metal, or a metal alloy, or a cermet composite;
selective laser sintering on a powder bed, the first material being, in particular, a polymer; or
stereolithography, the first material being, in particular, a photopolymerisable resin, more specifically a vat-photopolymerisable resin.

2. Method according to claim 1, wherein the infiltration step is carried out:
at a temperature of between 20 and 35° C., the second material or its precursor being, in particular, a liquid chosen from among organic compounds, inorganic compounds, polymers or their precursors, composites, metals chosen from among Hg and Ga; or
at a temperature greater than the melting point of the second material or of its precursor, in particular at a temperature corresponding to (the melting point of the second material or of its precursor+around 50° C.), the second material being, in particular, a metal or a metal alloy, for example Al;
and/or
under a controlled atmosphere and/or pressure.

3. Method according to claim 1, wherein the precursor of the second material is:
a precursor forming the second material by drying or thermal treatment; and/or
a composition comprising a monomer and optionally a polymerisation catalyst, the second material being the corresponding polymer; or
a composition comprising a polymer and a cross-linking agent or a hardener, the second material being the corresponding cross-linked or hardened polymer.

4. Method according to claim 1 wherein:
the selective laser printing steps is preceded by a step of digitally pre-treating the matrix; and/or
the infiltration step is followed by a drying and/or thermal treatment step, in particular to obtain the second material from a precursor.

5. Method according to claim 1, wherein the first material is constituted or comprise a metal or a metal alloy; a polymer;
or a ceramic; the first material being, in particular, constituted of a metal or of a metal alloy, the first material being, in particular, constituted or comprising:
a metal chosen from among Ti, Al, Fe, Co, Cr and their alloys, in particular Ti—Al, Al—Si, Fe—C, Cu—Sn, Cu—Zn, or Co—Cr;
a thermoplastic polymer, in particular chosen from among polyamides, for example, Nylon 6, Nylon 11 and Nylon 12, amide copolymers, for example nylon 6-12, polyacetates, polyethylenes, polyetheretherketones, acrylonitrile butadiene styrenes, polylactic acids, polyethylene terephthalates, high-density polyethylenes, polyetherimides, and their mixtures;
a photopolymerisable resin, in particular chosen from among acrylate compounds, urethane-acrylate compounds, epoxy compounds, epoxy-acrylate compounds, vinylether compounds and their mixtures, the first material comprising more specifically, further to the resin, a polymerisation initiator and/or a colourant; or
a ceramic chosen from among oxides, for example, alumina, nitrides, for example AlN, carbides, for example WC and TiC, borides, for example TiB, and ceramic/metal composites, for example Al₂O₃/Al composites, in particular the cermet Al₂O₃+5% Al.

6. Method according to claim 1 wherein the second material is such that its melting point or its liquid state temperature is less than the melting point or liquid state temperature of the first material, in particular less than the melting point of the first material, in particular, preferably, of at least 20%.

7. Method according to claim 1, wherein the second material is chosen from among:
organic compounds, in particular:
organic solvents, more specifically methanol, acetone and ethanol;
hydrocarbons;
biological liquids, for example, blood;
polymers, more specifically casting resins, for example, polyepoxides, acrylic resins, vinyl resins, polyurethanes and polyesters;
inorganic compounds, in particular:
water;
metals and their alloys, in particular containing the elements Al, Sn, Zn, Cu, Fe, Ag, Au, Hg and/or Ga;
composites, in particular composite resins containing magnetic fillers, for example NdFeB, ferromagnetic ceramics: ferrite, or magnetisable ferromagnetic ceramics, for example iron-based composites.

8. Method according to claim 1, wherein the size t is between around 70 and around 700 μm; or the size (tₐ) is between around 70 and around 350 μm, and the size (t_{b}) is between around 350 and around 700 μm.

9. Method according to claim 1, wherein the matrix is a lattice structure matrix, in particular constituted or comprising an elementary geometric pattern, in particular cubic, which is repeated periodically in the space, the lattice structure matrix being more specifically a beam structure matrix, the diameter of said beams being even more specifically of 100 to 300 μm, for example graded of relative densities or topology-graded.

10. Device which can be obtained by the method such as defined according to claim 1.

11. Use of a device according to claim 10, in the automotive, aerospace, aeronautics or biomedical field, in particular as an implantable system, enabling, for example, a localised salting-out of medicine(s), or as a perpetual pumping system, in particular, as a filtering system in the biomedical field.
